(19) United States
(12) Patent Application Publication
(10) Pub. No.: US 2006/0122305 A1
(43) Pub. Date: Jun. 8, 2006

(54) Pumpable self-levelling magnesia floor finish

(75) Inventor: Manfred Lechner, Vienna (AT)

Correspondence Address: CHAPMAN AND CUTLER, 111 WEST MONROE STREET, CHICAGO, IL, 60603, US

(73) Assignee: Styromagnesit Steirische Magnesitindustrie GmbH., St. Katharein/Laming (AT)

(21) Appl. No.: 11/207,653

(22) Filed: Aug. 18, 2005

(30) Foreign Application Priority Data
Aug. 19, 2004 (AT) A 1400/2004

(51) Int. Cl. C08K 3/22; C08K 3/34

(52) U.S. Cl. 524/433; 524/442

(57) ABSTRACT

In the case of a pumpable self-levelling magnesia floor finish containing caustic calcined magnesia, MgCl₂, water and quartz sand, epoxy resins are added in a ratio to MgCl₂ in quantities of 1:2 to 1:4 parts by weight as well as hardener and organic acid to adjust the rate of setting.

### BACKGROUND OF THE INVENTION

1. Field of the Invention

The invention relates to a pumpable self-levelling magnesia floor finish containing caustic calcined magnesia, MgCl₂, water and quartz sand. Such pumpable self-levelling floor finishes can be applied in a simple manner in particular onto a dry and dust-free substrate, primer coats having been suggested onto which magnesia floor finish is subsequently applied.

Existing recipes for pumpable self-levelling magnesia floor finishes usually do not allow high strength, thin layer cast coatings to be produced, thin layer coatings having to be understood to mean coatings with a layer thickness of approximately 5 mm or less. The capillary porosity of magnesia floor finishes tend to cause cracking when subjected to corresponding pressure or flexural tension, in which connection, particularly in the case of a low resistance to chloride of the primer coats used, there is the danger of the formation of bubbles and surface irregularities which in turn promote the risk of cracking and breaking.

In AT-U 7007, a recipe has already been suggested which is characterised by an improved tensile strength in bending and compressive strength even in the case of thin layers such that the suitability of existing floor coverings for being repaired was improved. Such cast coatings have also contained organic dispersions apart from the known constituents of caustic calcined magnesia, magnesium chloride, water and quartz sand. The organic dispersions were aimed at reducing the capillary porosity and achieving more homogeneous mixing of the aggregates and, in particular, the quartz sand and/or the caustic calcined magnesia. In compulsory mixers, a considerably more homogeneous mixture was in fact observed in a considerably shorter time such that more easily pumpable masses are obtained which remain pumpable even with a relatively low proportion of water in order to allow rapid drying times.

Such polymer-modified coatings are consequently essentially aimed at closing the capillary pores in which case, however, the surface hardness decreases during prolonged storage in water and, moreover, staining of the surface occurs and, overall, a surface hardness insufficient for high levels of stress and an unsatisfactory resistance to abrasion are achieved. In contrast to the improvement in the compressive strength and the tensile strength in bending in the case of floor finishes not modified with synthetic resin dispersions, there continue to be disadvantages in the case of a high level of wear and tear and a high abrasion impact and a risk of water stains forming.

The invention is now aimed at creating a pumpable self-levelling magnesia floor finish of the above-mentioned type by means of which, in addition to the advantages already achieved by polymer modification, improvements in the surface hardness and the resistance to abrasion as well as the water resistance can be achieved. To achieve this task, the magnesia floor finish according to the invention consists essentially of epoxy resins being added in a ratio to MgCl₂ in quantities of 1:2 to 1:4 parts by weight as well as hardeners and organic acids to adjust the rate of setting. As a result of the fact that epoxy resin and in this case again in particular two-component resins are used, two independently occurring reactions are observed during curing which do not impede each other, such that the formation of two interwoven networks occurs which complement each other, as a result of which a greater surface hardness and load bearing capacity of thin-layer coatings are obtained. Curing of the two-component epoxy, resin system leads to the formation of a second binding structure parallel to the Sorel bond, better flow properties and consequently an improvement in the processability being simultaneously observed. A problem when combining a Sorel bond and epoxy resin hardener, however, is the fact that curing takes place basically extremely rapidly, as a result of which relatively short processing times may arise. In order to guarantee a corresponding adjustability of the rate of setting, organic acids, and in this case again in particular citric acid, are added, according to the invention, to the pumpable self-levelling mixture. Such organic acids lead to a delay in setting during the formation of the Sorel bond. Although, as a result of such organic acids, the rate of setting of epoxy resins is accelerated, as a result of the corresponding addition of organic acid, however, an improved pumpability and a satisfactory curing time are simultaneously obtained, in which case it is, in particular, no longer necessary to smooth the material and/or to apply a stopper coat at the end of the curing time. In this way, a number of advantages are achieved both regarding the processing time and during after-treatment, the epoxy resin structure now providing the possibility of laying floors free from cracks and shrinkage in layer thicknesses of 5 mm. The second support structure formed by the epoxy resin bond in the magnesia bond prevents the shrinkage and the expansion of the coating, the increased surface hardness and the improved resistance to abrasion being accompanied by an improved resistance to chemicals in comparison with conventional magnesia floor finishes. This improved resistance to chemicals is the result of the additional protective layer based on resins and in particular on polyurethane resins. An improved resistance to water is achieved by the addition of the epoxy resin alone since this effectively closes the capillary pores and penetrates into the pores.

An optimum adjustability of the rate of setting and the curing behaviour can be achieved according to the invention preferably by organic acids, in particular citric acid, being added in quantities of between 0.5 and 5% by weight, based on MgCl₂.

As has already been suggested in connection with polymer-modified magnesia floor finishes, it is advantageous within the framework of the invention to add additives, and in particular defoaming agents and/or surface active additives in quantities of between 0.05 and 2% by weight, based on the mixture as a whole. Suitable additives in this case are preferably polyether-modified polydimethyl siloxanes, emulsions of paraffin-based mineral oils or hydrophobic components as well as propylene glycol and/or tripropylene glycol methyl ether. A particularly high resistance to abrasion is guaranteed by choosing a corresponding grading curve for quartz sand and glass microspheres. Advantageously, the procedure for this purpose consists of using quartz sand with a grain size of between 0.3 and 0.1 mm and glass microspheres with a grain size of less than 0.2 mm in a weight ratio of 20:1 to 3:1, based on the quantity of quartz sand and additionally quartz meal with a grain size of less 0.05 mm.

Basically, the pumpable self-levelling mixture can be stored in corresponding containers for prolonged periods, the epoxy resin being advantageously used as a solid emulsion in the corresponding plastic containers. Advantageously, the form as supplied is selected in such a way that the pumpable self-levelling magnesia floor finish is produced from three components, a first component containing the epoxy resin solids emulsion, a further component MgCl₂×6 H₂O, hardener, citric acid, ethanol and defoaming agent and the third component containing MgO and quartz sand. The epoxy resin solids emulsion as well as the equally liquid phase containing the hardener can be supplied in the corresponding plastic containers, whereas the third component can be delivered in bags.

Basically, the processing temperature should be between 10° and 25° C. and be at least 3° C. above the dew point. The relative atmospheric humidity should be between 40 and 80% in order to guarantee optimum curing. By way of the formation, according to the invention, of two separate support structures in the cured floor finish, wet-in-wet laying of the thin-layer coating is also possible.

The magnesia floor finish according to the invention is characterised by a compressive strength of the order of magnitude of 60 N/mnm², a tensile strength in bending of the order of magnitude of 15 N/mm², a density at 20° C. of approximately 1.9 g/cm³, a resistance to abrasion of approximately 700 mg/1000 U, 1000 g, H22 Rad and a surface hardness (Shore D) of >85. The conductivity values measured as earth leakage resistance were determined as being <10 MOhn.

### PRACTICAL EXAMPLES

### Example 1

In detail, the above-mentioned three components have the following composition

| 1^{st} component | | |
|---|---|---|
| a) | Epoxy resin | 5.72% by weight |
| | (bisphenol-A epichlorohydrin | |
| | solid resin emulsion solution | |
| | in H₂O with an epoxide- | |
| | equivalent weight of | |
| | approximately 1000 (solids | |
| | content approximately 53%, | |
| | equivalent weight | |
| | approximately 990)). | |
| 2^{nd} component | | |
| a) | Hardener | 1.59% by weight |
| | (epoxy resin amine adduct | |
| | solution in H₂O with an H- | |
| | equivalent weight of | |
| | approximately 200 | |
| | (approximately 73% solution, | |
| | equivalent weight | |
| | approximately 190)) | |
| b) | MgCl₂*6 H₂O | 14.63% by weight |
| c) | Water | 9.75% by weight |
| d) | Citric acid | 0.08% by weight |
| e) | Defoaming agent | 0.75% by weight |
| | (polysiloxane/combination of | |
| | fatty acid silicic acid white | |
| | oil (polyether-modified | |
| | polymethyl siloxane, | |
| | combination of modified, non- | |
| | ionogenic fatty substances, | |
| | hydrophobic silicic acid and | |
| | aromatics-free medically safe | |
| | white oils)) | |
| f) | Alcohols | 0.75% by weight |
| | (ethanol) | |
| g) | Surface active additive | 0.35% by weight |
| | (modified glycol methyl ether | |
| | (tripropylene glycol methyl | |
| | ether)) | |
| 3^{rd} component | | |
| a) | MgO | 23.40% by weight |
| b) | Quartz sand (ME 23; ‘F 32 | 32.37% by weight |
| c) | Quartz meal (W 6/W 8) | 5.15% by weight |
| d) | Glass microspheres (CP 03) | 3.19% by weight |

When mixing these three components while keeping to the weight percentages indicated, any contaminants which make up the total quantity to 100% by weight have not been indicated in detail.

### Example 2

| 1^{st} component | | |
|---|---|---|
| a) | Epoxy resin | 5.72% by weight |
| | (bisphenol-A epichlorohydrin | |
| | solid resin emulsion solution | |
| | in H₂O with an epoxide- | |
| | equivalent weight of | |
| | approximately 600 (591)). | |
| 2^{nd} component | | |
| a) | Hardener | 1.84% by weight |
| | (epoxy resin amine adduct | |
| | solution in H₂O with an H- | |
| | equivalent weight of | |
| | approximately 200 | |
| | (approximately 73% solution, | |
| | equivalent weight | |
| | approximately 190)) | |
| b) | MgCl₂*6 H₂O | 14.84% by weight |
| c) | Water | 9.82% by weight |
| d) | Citric acid | 0.06% by weight |
| e) | Defoaming agent | 0.75% by weight |
| | (polysiloxane/combination of | |
| | fatty silicic acid white oil | |
| | (polyether-modified | |
| | polymethyl siloxane, | |
| | combination of modified, non- | |
| | ionogenic fatty substances, | |
| | hydrophobic silicic acid and | |
| | aromatics-free medically safe | |
| | white oils)) | |
| f) | Alcohols | 0.25% by weight |
| | (ethanol) | |
| g) | Surface active additive | 0.35% by weight |
| | (modified glycol ethyl ether | |
| | (tripropylene glycol methyl | |
| | ether)) | |
| h) | Flow promoter | 0.30% by weight |
| | (polymeric sulfonated | |
| | melamine/Mg lignin sulfonate) | |
| 3^{rd} component | | |
| a) | MgO | 23.60% by weight |
| b) | Quartz sand (ME 23; F 32) | 33.85% by weight |
| c) | Quartz meal (W 6/W 8) | 5.20% by weight |
| d) | Glass microspheres (CP 03) | 3.42% by weight |

In this case, too, contaminants which make up the total quantity to 100% by weight have not been indicated separately.

The components selected make it possible to guarantee, in each case, a corresponding storage time for the starting substance, the curing process beginning immediately after the components having been combined and the corresponding final strength values being achieved within the times indicated above. Temperatures between 10° C. and 25° C. were chosen as processing temperatures, it being necessary to maintain a relative humidity in the region of 40 to 80% by weight. In both examples, the 2^{nd} component was introduced into the 1^{st} first component and homogenised whereupon the solids of the 3^{rd} component were added to the liquid mixture with stirring. Following completed homogenisation, the mass was cast onto the surface to be coated and distributed with a pin coating knife. Subsequently, after-treatment was carried out with a shaking facility. It was possible to apply a sealant 12 to 24 hours after laying of the coating.

In general it is necessary for the surface to be primed to be dry and preferably have a residual moisture content of maximum 4% in the case of cement-bound floors and of 0.5% by weight in the case of anhydrite substrates.

Depending on the quality of the substrate, this can also be prepared by bead blasting or similar methods. The adhesive strength under tension should as a rule be at least 1.0 N/mm².

What I claim is:

1. Pumpable self-levelling magnesia floor finish containing caustic calcined magnesia, MgCl₂, water and quartz sand, characterised in that epoxy resin is added in a ratio to MgCl₂ in quantities of 1:2 to 1:4 parts by weight as well as hardener and organic acids to adjust the rate of setting.

2. Pumpable self-levelling magnesia floor finish according to claim 1 characterised in that organic acids, in particular citric acid, are added in quantities between 0.05 and 5% by weight, based on MgCl₂.

3. Pumpable self-levelling magnesia floor finish according to claim 1 or 2 characterised in that additives, in particular defoaming agents and/or surface active additives are added in quantities of between 0.5 and 2% by weight, based on the total mixture.

4. Pumpable self-levelling magnesia floor finish according to claim 1, 2 or 3 characterised in that quartz sand with a grain size of between 0.3 and 0.1 mm as well as glass microspheres with a grain size of less than 0.2 mm are added in a quantitative ratio of 20:1 to 3:1, based on the quantity of quartz sand and, in addition quartz meal with a grain size of less than 0.05 mm.

5. Pumpable self-levelling magnesia floor finish according to any one of claims 1 to 4 characterised in that epoxy resin is used as solids emulsion.

6. Pumpable self-levelling magnesia floor finish according to any one of claims 1 to 5 characterised in that the mixture is produced from three components, a first component containing the epoxy resin solids emulsion, a further component MgCl₂×6 H₂O, hardener, citric acid, ethanol and defoaming agent and the third component MgO and quartz sand.
